(19) United States
(12) Patent Application Publication
(10) Pub. No.: US 2025/0319548 A1
(43) Pub. Date: Oct. 16, 2025

(54) LASER WELDING METHOD FOR STACKED METAL FOILS

(71) Applicant: Panasonic Intellectual Property Management Co., Ltd., Osaka (JP)

(72) Inventors: Futoshi TSUTSUMI, Hyogo (JP); Naoya KATO, Osaka (JP)

(21) Appl. No.: 19/252,396

(22) Filed: Jun. 27, 2025

Related U.S. Application Data
(63) Continuation of application No. PCT/JP2023/042628, filed on Nov. 28, 2023.

(30) Foreign Application Priority Data
Jan. 6, 2023 (JP) 2023-001232

(51) Int. Cl. B23K 26/21; B23K 26/32

(52) U.S. Cl. CPC B23K 26/21; B23K 26/32

(57) ABSTRACT

There is provided a laser welding method for stacked metal foils including a plurality of stacked copper-based foils. The laser welding method includes: vertically stacking the plurality of copper-based foils; arranging the stacked metal foils on a jig in a blue laser welding system; and irradiating the stacked metal foils with a blue laser beam set to face toward a prescribed direction. After the irradiation with the blue laser beam, in a cross section of the stacked metal foils along a stacking direction of the copper-based foils, a lower end surface of a melted region generated in the stacked metal foils does not curve to a center side of the melted region.

### CROSS-REFERENCE TO RELATED APPLICATIONS

The present application is a continuation application of PCT/JP2023/042628 that claims priority to Japanese Patent Application No. 2023-001232 filed on Jan. 6, 2023, the entire content of which is incorporated herein by reference.

### TECHNICAL FIELD

The present disclosure relates to a laser welding method for stacked metal foils.

### BACKGROUND ART

JP2019-005768A discloses a welding method for stacked metal foils in which stacked metal foils sandwiched between a pair of metal plates are welded to the pair of metal plates. Specifically, the welding method includes locally pressing and crimping the stacked metal foils sandwiched between the pair of metal plates in a stacking direction at a prescribed welding portion, and welding the crimped pair of metal plates and the stacked metal foils at the prescribed welding portion. In particular, in the welding step, the welding is performed by irradiating the prescribed welding portion with a laser beam, an irradiation condition of the laser beam is feedback-controlled based on an intensity of thermal radiation light radiated from a melt pool formed by irradiating the prescribed welding portion with the laser beam, contact of the melt pool with a base on which the pair of metal plates and the stacked metal foils are placed is detected based on the intensity of the thermal radiation light, and the irradiation of the melt pool with the laser beam is ended when the contact of the melt pool with the base is detected.

### SUMMARY OF INVENTION

The present disclosure provides a laser welding method for stacked metal foils that prevents a melted portion on a lower end side in a stacking direction of stacked metal foils from curving to a center side of the melted portion regardless of a deviation of an irradiation position of laser light and a variation in the metal foils.

According to an illustrative aspect of the present disclosure, a laser welding method for stacked metal foils including a plurality of stacked copper-based foils includes: vertically stacking the plurality of copper-based foils; arranging the stacked metal foils on a jig in a blue laser welding system; and irradiating the stacked metal foils with a blue laser beam set to face toward a prescribed direction. After the irradiation with the blue laser beam, in a cross section of the stacked metal foils along a stacking direction of the copper-based foils, a lower end surface of a melted region generated in the stacked metal foils does not curve to a center side of the melted region.

According to the aspect of the present disclosure, a laser welding method for stacked metal foils can prevent a melted portion on a lower end side in a stacking direction of the stacked metal foils from curving to a center side of the melted portion regardless of a deviation of an irradiation position of laser light and a variation in the metal foils.

### BRIEF DESCRIPTION OF DRAWINGS

FIG. 1 is a schematic view illustrating a configuration example of a laser welding system according to an embodiment;

FIG. 2 is a schematic view illustrating a cross section taken along a line A-A in FIG. 1;

FIG. 3 illustrates how stacked metal foils are clamped to a jig;

FIG. 4 schematically illustrates an example of vector decomposition of a force applied in a stacking direction when the stacked metal foils are laser-welded by a blue laser beam;

FIG. 5 is a process view schematically illustrating time-series operation procedures when the stacked metal foils are laser-welded;

FIG. 6 illustrates a central cross section in a vicinity of a melted region by first laser welding;

FIG. 7 illustrates the central cross section in the vicinity of the melted region by second laser welding; and

FIG. 8 illustrates a comparative example of results of laser welding depending on a shape of a jig.

### DESCRIPTION OF EMBODIMENTS

### (Background of Present Disclosure)

It is known that laser welding of a copper-based material, which contains copper as a main component, is fairly difficult since the copper-based material generally has high reflectance, high thermal conductivity, and high heat capacity. Welding methods such as infrared (IR) laser welding using light having a wavelength of an IR band and ultrasonic welding have been developed as laser welding of the copper-based material. Even when these welding methods are used, however, it is said that it is still difficult to perform high-quality laser welding on the copper-based material while shortening a takt time. A welded product obtained by stacking and laser-welding the copper-based material is used, for example, as an electrode of a secondary battery (battery) mounted on an electronic device or an autonomous driving vehicle. Therefore, a technique for welding the copper-based material with high quality inevitably attracts attention in consideration of battery production. That is, there is a demand for a laser welding technique that shortens the tact time and achieves excellent welding quality.

In a configuration of JP2019-005768A, it is inevitable to perform a crimping step to minimize a gap between a plurality of metal foils constituting the stacked metal foils. The stacked metal foils including a plurality of vertically stacked metal foils are sandwiched between the pair of metal plates from an upper side to a lower side, and there is accordingly a problem that laser welding cannot be performed only on the metal foils. On the other hand, for example, when the metal foils are crimped and laser-welded in the air (that is, in a state in which the metal foils are not sandwiched between the pair of metal plates), in a cross-sectional structure of a melted portion that is a welding portion, an end surface in a lower portion (non-irradiation side) of the melted portion which is difficult to be irradiated with a laser tends to curve inward (that is, in a direction to a center side of the melted portion in the entire melted portion). This is considered to be due to thermal contraction caused by irradiation with laser light.

In the laser welding of the stacked metal foils, it is desirable from a viewpoint of improving electrical conductivity that the melted portion have a cross-sectional area as large as possible, and that end surfaces in an upper portion and the lower portion of the melted portion that are close to surfaces do not curve. However, in an actual production site (process), a laser irradiation position may deviate and a workpiece (stacked metal foils) itself may vary, and the end surface in the lower portion (non-irradiation side) of the melted portion that is difficult to be irradiated with the laser tends to curve inward (that is, in the direction to the center side of the melted portion in the entire melted portion) regardless of the deviation and the variation. For this reason, when laser welding can be performed such that the end surface in the lower portion of the melted portion of the workpiece (stacked metal foils) is prevented from curving inward, it is possible to implement laser welding with high likelihood (in other words, high quality) for the copper-based material, and an ideal cross-sectional structure of the melted portion can be obtained also from a viewpoint of the electrical conductivity described above.

Therefore, the following embodiment describes a laser welding method for stacked metal foils, which prevents a melted portion on a lower end side in a stacking direction of the stacked metal foils from curving to a center side of the melted portion regardless of a deviation of an irradiation position of laser light and a variation in the metal foils.

Hereinafter, the embodiment specifically disclosing the laser welding method for stacked metal foils according to the present disclosure will be described in detail with reference to the drawings as appropriate. Detailed description more than necessary may be omitted. For example, detailed description of well-known matters and redundant description of substantially the same configuration may be omitted. This is to avoid redundancy of following description and facilitate understanding of those skilled in the art. The accompanying drawings and the following description are provided for those skilled in the art to fully understand the present disclosure, and are not intended to limit subject matters described in the claims.

### Definitions of Terms

In the following description, a term “laser welding” has a meaning as wide as possible unless otherwise explicitly described, and includes welding, soldering, melting and refining, joining, annealing, softening, adhesion, resurfacing, peening, heat treatment, fusion, sealing, and stacking.

In the following description, a term “copper-based material” has a meaning as wide as possible unless otherwise explicitly described, and includes any one of copper, a copper material, a copper metal, a material electroplated with copper, a metal material containing at least substantially 10 wt % to 100 wt % of copper, a metal and an alloy that contain at least substantially 10 wt % to 100 wt % of copper, a metal and an alloy that contain at least substantially 20 wt % to 100 wt % of copper, a metal and an alloy that contain at least substantially 50 wt % to 100 wt % of copper, a metal and an alloy that contain at least about 70 wt % to 100 wt % of copper, and a metal and an alloy that contain at least substantially 90 wt % to 100 wt % of copper.

In the following description, terms “blue laser beam” and “blue laser” have a meaning as wide as possible unless otherwise explicitly described, and generally refer to a system that provides a laser beam, a laser beam, and a laser source (for example, diode laser) that provides and propagates a laser beam or light having a wavelength of substantially 400 nm to substantially 500 nm.

### (System Configuration)

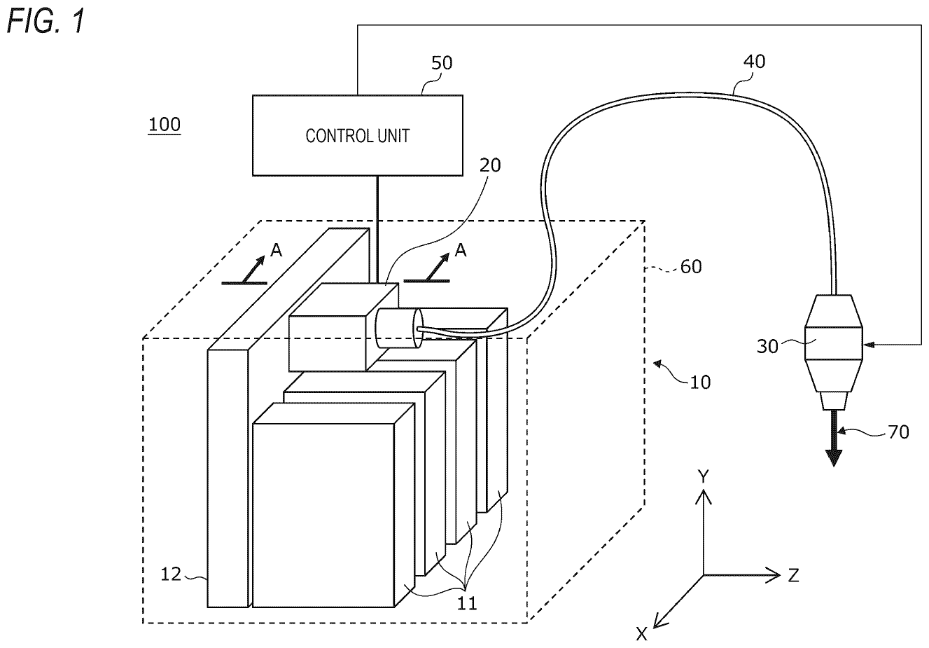

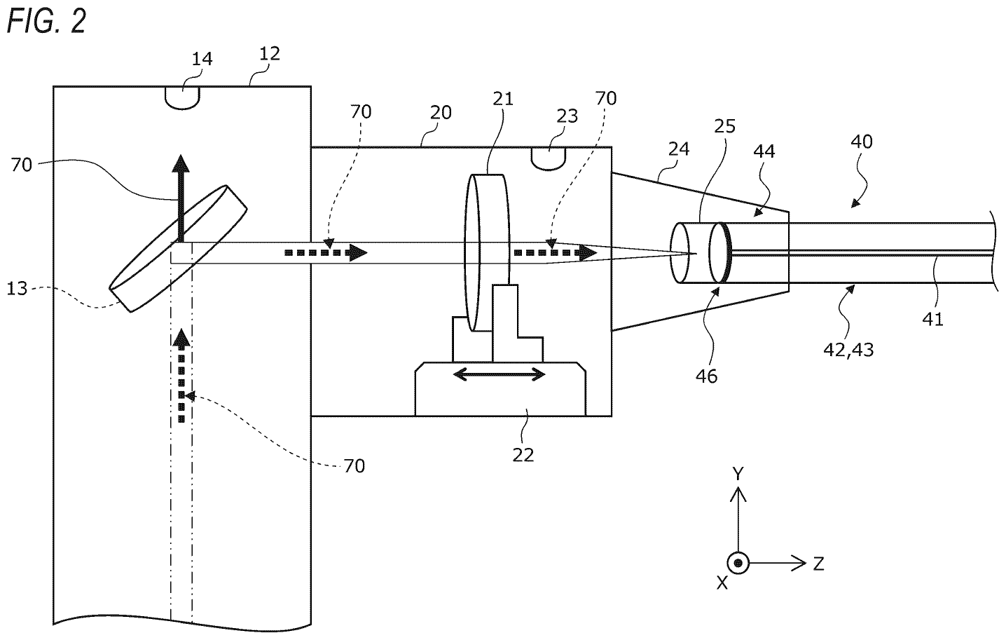

First, a configuration example of a blue laser welding system 100 according to the present embodiment will be described with reference to FIGS. 1 and 2. FIG. 1 is a schematic view illustrating the configuration example of the blue laser welding system 100 according to the present embodiment. FIG. 2 is a schematic view illustrating a cross section taken along a line A-A in FIG. 1. In the following description, X, Y, Z axes are defined as directions illustrated in FIGS. 1 and 2. That is, a direction in which a blue laser beam 70 in FIG. 2 travels toward a semi-transparent mirror 13 is defined as a Y direction, a direction from the semi-transparent mirror 13 toward a transmission fiber 40 is defined as a Z direction, and a direction orthogonal to the Y direction and the Z direction is defined as an X direction. The Z direction coincides with an optical axis direction of the blue laser beam 70 exiting from a condenser lens unit 20 within a range of assembly tolerance of an optical system of the blue laser welding system 100.

As illustrated in FIG. 1, the blue laser welding system 100 includes a laser oscillator 10, the condenser lens unit 20, a laser beam exiting head 30, the transmission fiber 40, and a control unit 50. The laser oscillator 10, the condenser lens unit 20, and a laser beam entrance portion 44 (see FIG. 2) of the transmission fiber 40 are housed in a housing 60. Here, in the present embodiment, laser light (blue laser beam 70) having a blue (that is, 400 nm to 500 nm) wavelength is used when performing the laser-welding on the stacked metal foils. This is because light having a blue wavelength has a characteristic of being absorbed by copper at a high absorption rate (up to substantially 65%).

The laser oscillator 10 includes a plurality of laser modules 11 and a beam combiner 12. Four laser modules 11 are illustrated in FIG. 1, and the number of laser modules is not limited to four and may be one. When the laser oscillator 10 includes one laser module 11, a configuration of the beam combiner 12 may be simplified. In the laser oscillator 10, laser beams of different wavelengths (different wavelengths such as 400 nm, 420 nm, 440 nm, and 480 nm in the range of 400 nm to 500 nm) exiting from the plurality of laser modules 11 are combined into one blue laser beam 70 by the beam combiner 12. The laser oscillator 10 may be referred to as a direct diode laser (DDL) oscillator. The laser module 11 itself includes a plurality of laser diodes, for example, a semiconductor laser array.

As illustrated in FIG. 2, the blue laser beam 70 wavelength-combined by the beam combiner 12 is condensed by a condenser lens 21 disposed in the condenser lens unit 20 and enters the transmission fiber 40. By configuring the laser oscillator 10 as described above, it is possible to obtain the high-powered blue laser welding system 100 having a laser beam output exceeding several kW. The beam combiner 12 includes the semi-transparent mirror 13 and an output light monitor 14 therein.

The semi-transparent mirror 13 deflects the blue laser beam 70 wavelength-combined by the beam combiner 12 toward the condenser lens unit 20 and transmits a part (for example, 0.1%) of the blue laser beam 70.

The output light monitor 14 is disposed in the beam combiner 12, receives the blue laser beam 70 transmitted through the semi-transparent mirror 13 and generates a detection signal corresponding to the light amount of the received blue laser beam 70. The laser oscillator 10 is supplied with electric power from a power supply device (not illustrated) to perform laser oscillation.

The condenser lens unit 20 includes therein the condenser lens 21, a slider 22, and a reflected light monitor 23. The condenser lens 21 condenses the blue laser beam 70 on an entrance end surface 46 of the transmission fiber 40 such that a spot diameter is smaller than a diameter of a core 41 of the transmission fiber 40. The slider 22 holds the condenser lens 21 such that the condenser lens 21 is automatically movable in the Z direction according to a control signal from the control unit 50. The slider 22 is coupled to, for example, a ball screw (not illustrated) driven by a motor (not illustrated), and moves in the Z direction as the ball screw rotates. The slider 22 mainly moves in the X and Y directions during initial position adjustment of the optical system, and moves along the Z direction during shift compensation of a focal position. The slider 22 may be manually or automatically moved in the X and Y directions. In a case of automatic movement, the slider 22 is coupled to the above-described ball screw (not illustrated) or the like. The reflected light monitor 23 receives the blue laser beam 70 reflected or scattered by the laser beam entrance portion 44 of the transmission fiber 40, and generates a detection signal corresponding to the light amount of the received blue laser beam 70. The condenser lens unit 20 further includes a connector 24. The laser beam entrance portion 44 of the transmission fiber 40 is connected to the connector 24. The connector 24 holds a quartz block 25 provided in contact with the entrance end surface 46 of the transmission fiber 40. The quartz block 25 has a function of protecting the entrance end surface 46.

The transmission fiber 40 is optically joined to the laser oscillator 10 and the condenser lens 21, and transmits the blue laser beam 70 received from the laser oscillator 10 through the condenser lens 21 to the laser beam exiting head 30. The transmission fiber 40 includes the core 41 that transmits the blue laser beam 70, a cladding 42 that is provided around the core 41 and has a function of confining the blue laser beam 70 in the core 41, and a coating film 43 that covers a surface of the cladding 42. The laser beam entrance portion 44 of the transmission fiber 40 is provided with a mode stripper (not illustrated). Although not illustrated, the mode stripper is also provided in a laser beam exiting portion of the transmission fiber 40.

The laser beam exiting head 30 radiates the blue laser beam 70 transmitted through the transmission fiber 40 toward the outside (for example, stacked metal foils described later). The laser beam exiting head 30 includes, for example, a collimator, a reflecting mirror, a condenser lens, and a laser light scanner as optical components. These optical components are housed in a housing of the laser beam exiting head 30 while maintaining a prescribed positional relationship (for example, see FIGS. 1 and 2 of JP2022-060808A).

The collimator receives the blue laser beam 70 exiting from the transmission fiber 40, and converts the blue laser beam 70 into parallel light to enter the reflecting mirror. The collimator is coupled to a driving unit (not illustrated) and is displaceable in the Y direction according to a control signal from the control unit 50. By displacing the collimator in the Y direction, a focal position of the blue laser beam 70 can be changed, and the blue laser beam 70 can be appropriately radiated according to a shape of a workpiece (for example, stacked metal foils). That is, the collimator also functions as a focal position adjustment mechanism of the blue laser beam 70 in combination with the driving unit (not illustrated). The focal position of the blue laser beam 70 may be changed by displacing the condenser lens by the driving unit (not illustrated).

The reflecting mirror reflects the blue laser beam 70 transmitted through the collimator to enter the laser light scanner. A surface of the reflecting mirror defines substantially 45 degrees with an optical axis of the blue laser beam 70 transmitted through the collimator.

The condenser lens condenses the blue laser beam 70 reflected by the reflecting mirror and directed by the laser light scanner on a surface of the workpiece (for example, stacked metal foils).

The laser light scanner is a known galvano scanner including a first galvano mirror and a second galvano mirror. The first galvano mirror includes a first mirror, a first rotation shaft, and a first driving unit. The second galvano mirror includes a second mirror, a second rotation shaft, and a second driving unit. The blue laser beam 70 transmitted through the condenser lens is reflected by the first mirror and further reflected by the second mirror, and is radiated to the surface of the workpiece (for example, stacked metal foils).

For example, the first driving unit and the second driving unit are galvano motors, and the first rotation shaft and the second rotation shaft are output shafts of the motors. Although not illustrated, the first driving unit is rotationally driven by a driver that operates in response to a control signal from the control unit 50, and thereby the first mirror attached to the first rotation shaft rotates about an axis of the first rotation shaft. Similarly, the second driving unit is rotationally driven by a driver that operates in response to a control signal from the control unit 50, and thereby the second mirror attached to the second rotation shaft rotates about an axis of the second rotation shaft.

The first mirror is rotated to a prescribed angle about the axis of the first rotation shaft, and thereby the blue laser beam 70 is directed in the X direction. The second mirror is rotated to a prescribed angle about the axis of the second rotation shaft, and thereby the blue laser beam 70 is directed in the Z direction. That is, the laser light scanner two-dimensionally scans the blue laser beam 70 in an XZ plane and radiates the blue laser beam 70 toward the workpiece (for example, stacked metal foils).

For example, when the blue laser welding system 100 is used for welding (for example, joining) a plurality of copper-based material foils (hereinafter, simply referred to as “copper foils”), the blue laser beam 70 is radiated toward the plurality of stacked copper foils (example of stacked metal foils) that sandwich a flat top surface TOP1 in a prescribed position (for example, jig JG1 to be described later).

The control unit 50 controls laser oscillation of the laser oscillator 10. Specifically, the control unit 50 controls laser oscillation by controlling an output, an ON time, and the like of a power supply device (not illustrated) connected to the laser oscillator 10. The control unit 50 may further include a lens movement control unit (not illustrated). The lens movement control unit (not illustrated) receives detection signals of the reflected light monitor 23 and the output light monitor 14 and moves the slider 22 to adjust the condenser lens 21 to a desired position. When the blue laser welding system 100 is used for welding (for example, joining) the plurality of copper foils described above, the control unit 50 may control operation of a manipulator (not illustrated) to which the laser beam exiting head 30 is attached.

### [Arrangement of Stacked Metal Foils]

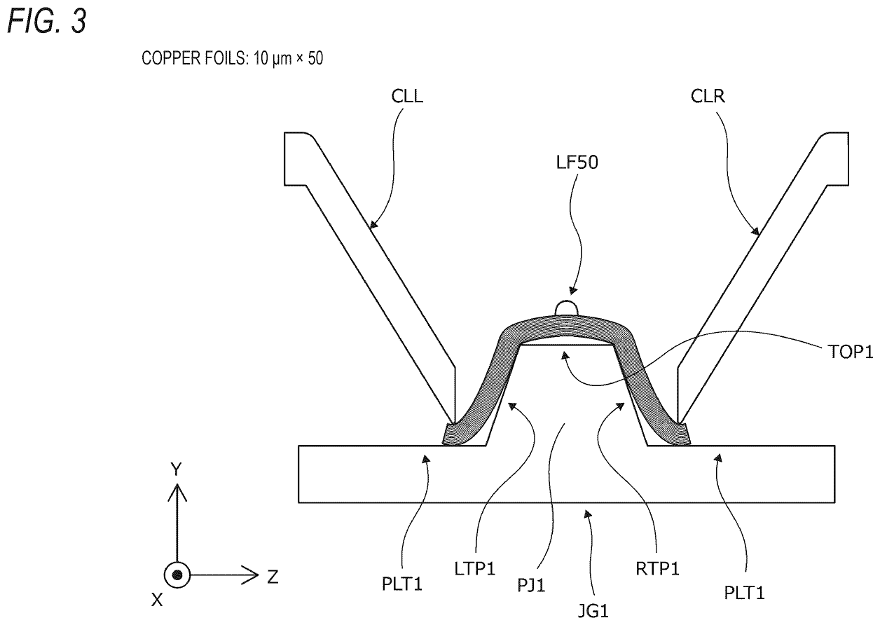

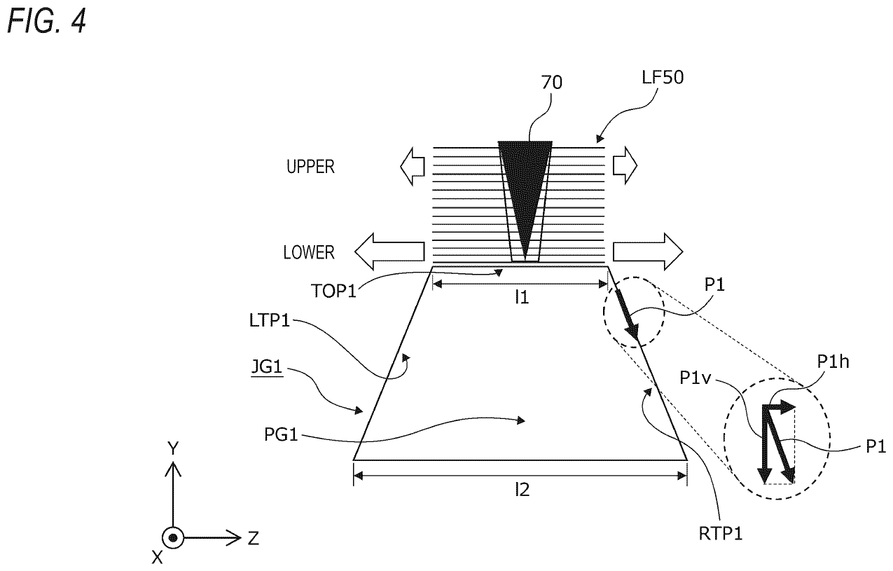

Next, an arrangement of stacked metal foils LF50 on the jig JG1 in the blue laser welding system 100 according to the present embodiment will be described with reference to FIGS. 3 and 4. FIG. 3 illustrates how the stacked metal foils LF50 are clamped to the jig JG1. FIG. 4 schematically illustrates an example of vector decomposition of a force applied in a stacking direction when the stacked metal foils LF50 are laser-welded by the blue laser beam 70. In the present embodiment, as an example, the stacked metal foils LF50 are formed by vertically stacking 50 copper foils (thickness: 10 μm). However, it is needless to say that the number of copper foils constituting the stacked metal foils LF50 is not limited to 50, and the thickness of the copper foil is not limited to 10 μm.

The stacked metal foils LF50 are arranged on the jig JG1 in a state in which the 50 copper foils are stacked in the stacking direction (vertical direction or Y direction). The jig JG1 plays a role of stably supporting and fixing the stacked metal foils LF50 during irradiation with the blue laser beam 70 together with a pair of clamp portions CLL and CLR. In the jig JG1, a pair of planar portions PLT1 and a projecting portion PJ1 projecting in the Y direction from the pair of planar portions PLT1 are integrally formed. The projecting portion PJ1 is formed in a trapezoidal columnar shape, having a flat top surface TOP1 corresponding to an upper surface of the trapezoidal columnar shape, and a pair of tapered surfaces LTP1 and RTP1 inclined substantially in a direction of gravity (that is, −Y direction) from respective two ends of the flat top surface TOP1 to left and right. A lower surface of the trapezoidal column of the projecting portion PJ1 is flush with the pair of planar portions PLT1. The shape of the jig JG1 is not limited to the shape illustrated in FIG. 3, however, even in a shape other than the shape illustrated in FIG. 3, it is necessary to form both the flat top surface TOP1 and the pair of tapered surfaces LTP1 and RTP1 inclined from two ends of the flat top surface TOP1.

In the example of FIG. 3, the stacked metal foils LF50 are fixed (clamped) to the jig JG1 over the tapered surface LTP1, the flat top surface TOP1, and the tapered surface RTP1. Specifically, one side (for example, left side) of the stacked metal foils LF50 is gripped (fixed) by the clamp portion CLL earlier in time, and the other side (for example, right side) of the stacked metal foils LF50 is gripped (fixed) by the clamp portion CLR later in time. For this reason, as illustrated in FIG. 3, it can be seen that the stacked metal foils LF50 are in contact with the tapered surface LTP1 more than the stacked metal foils LF50 are in contact with the tapered surface RTP1. The stacked metal foils LF50 may be in contact with the tapered surface RTP1 more than the stacked metal foils LF50 are in contact with the tapered surface LTP1. In any case, a slight gap is formed between a lowermost layer of the stacked metal foils LF50 and the flat top surface TOP1.

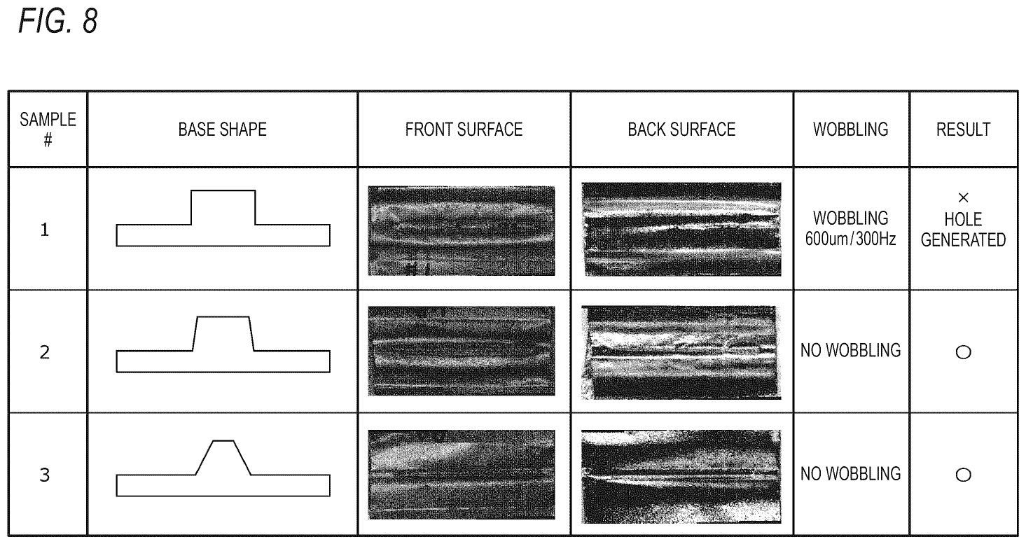

FIG. 4 illustrates only a part of the stacked metal foils LF50 in FIG. 3 which have a length equivalent to a width l1 of the flat top surface TOP1 in the Z direction. A ratio of the width l1 of the flat top surface TOP1 of the projecting portion PJ1 of the jig JG1 to a width l2 of a bottom surface of the projecting portion PJ1 of the jig JG1 is preferably equal to or larger than 3:5 and less than 1:1 (see FIG. 8). The blue laser beam 70 is radiated from an upper side (see FIG. 4) toward a lower side (see FIG. 4) of the stacked metal foils LF50 in a state in which the stacked metal foils LF50 are gripped (fixed) to the projecting portion PJ1 having the tapered surfaces LTP1 and RTP1.

Here, a case where the stacked metal foils LF50 are arranged on a rectangular parallelepiped projecting portion in which neither of the tapered surfaces LTP1 and RTP1 are provided in the projecting portion PJ1 is assumed as a comparative example (see FIG. 8). In this case, it is considered that a tensile force of each copper foil that presses the stacked metal foils LF50 against the rectangular parallelepiped projecting portion is generated only in a vertical direction (that is, −Y direction or downward in the stacking direction).

In the present embodiment, however, the tapered surfaces LTP1 and RTP1 are provided in the projecting portion PJ1. For this reason, for example, a tensile force P1, which is generated in the tapered surface RTP1 illustrated in FIG. 4, of each copper foil that presses the stacked metal foils LF50 against the trapezoidal columnar projecting portion PJ1 is dispersed in the vertical direction (for example, vector P1v in the −Y direction) and a horizontal direction (for example, vector P1h in the Z direction). By application of the tensile force in the horizontal direction, a gap between copper foils is further reduced or eliminated. In this manner, the blue laser beam 70 is radiated from the upper side (see FIG. 4) to the lower side (see FIG. 4) of the stacked metal foils LF50 in a state in which the stacked metal foils LF50 are arranged on the jig JG1 provided with the tapered surfaces LTP1 and RTP1 in the projecting portion PJ1.

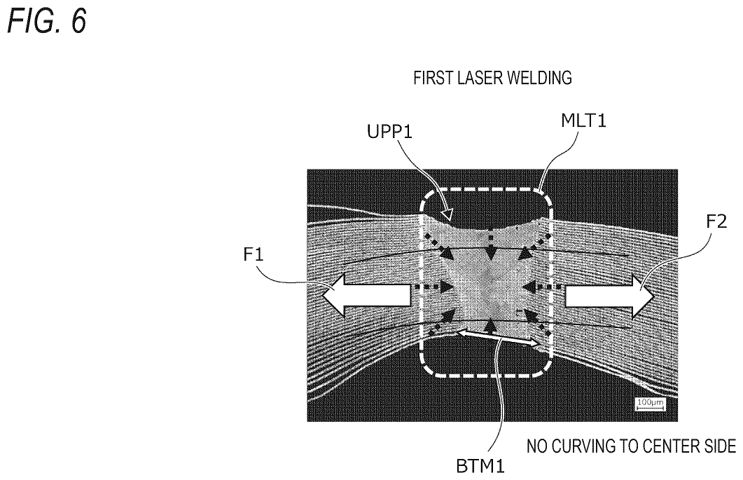

By the irradiation with the blue laser beam 70, each copper foil of the stacked metal foils LF50 starts to be gradually melted, and a force acts strongly to widen a melted region (melted volume) formed as a result of melting in a left-right direction from an upper portion side (that is, side away from the tapered surfaces LTP1 and RTP1) of the melted region to a lower portion side (that is, side close to the tapered surfaces LTP1 and RTP1). That is, forces F1 and F2 in directions relatively opposite to directions of thermal contraction in the melted region (specifically, directions from peripheral portions of the melted region toward a central portion, see eight dotted arrows in FIG. 6) formed based on the irradiation with the blue laser beam 70 act to reduce curvature of an end surface in a lower portion (lower end surface) of the melted region of the stacked metal foils LF50 to a center side of the melted region, resulting in a structure that does not curve.

### [Laser Welding of Stacked Metal Foils]

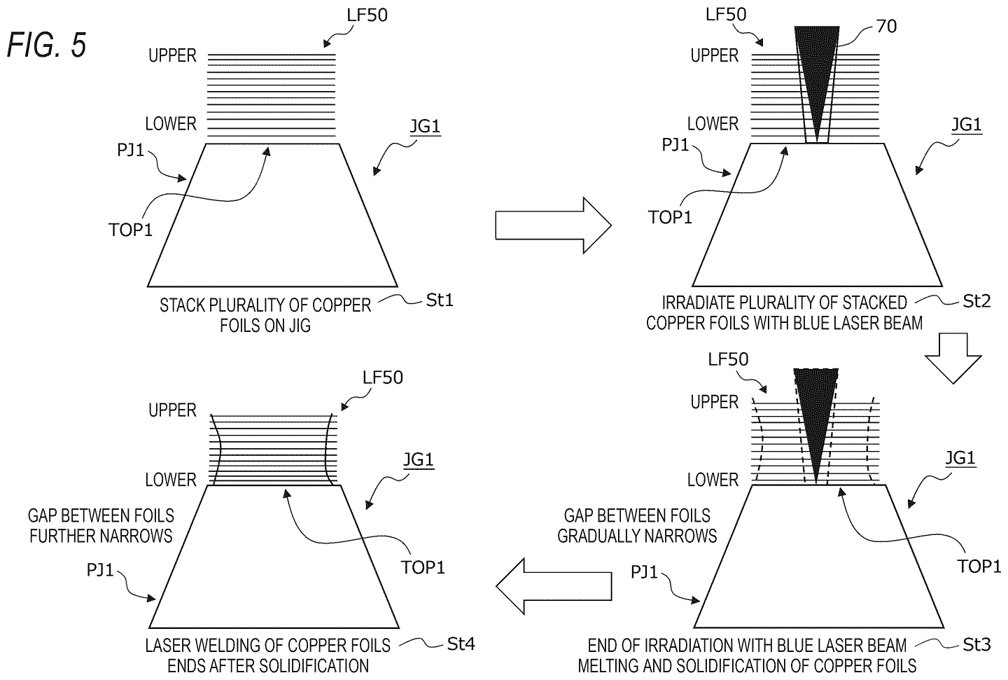

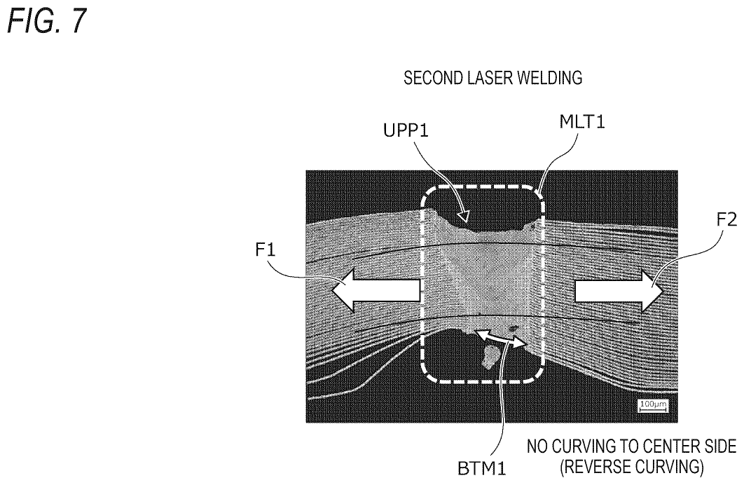

Next, time-series operation procedures of laser welding of the stacked metal foils LF50 by the blue laser beam 70 will be described with reference to FIGS. 5 to 7. FIG. 5 is a process view schematically illustrating the time-series operation procedures of laser welding of the stacked metal foils. FIG. 6 illustrates a central cross section in a vicinity of a melted region by first laser welding. FIG. 7 illustrates the central cross section in the vicinity of the melted region by second laser welding. The time-series operation procedures illustrated in FIG. 5 illustrate a laser welding method for the stacked metal foils LF50 using the blue laser welding system 100.

In FIG. 5, a plurality of (for example, 50) copper foils are stacked on the flat top surface TOP1 of the projecting portion PJ1 of the jig JG1 (step St1). Although not illustrated in FIG. 5, after the plurality of (for example, 50) copper foils are arranged on the flat top surface TOP1, the copper foils are gripped (fixed) along the tapered surfaces LTP1 and RTP1 by the clamp portions CLL and CLR (see FIG. 3). After step St1, a radiation direction of the blue laser beam 70 (blue laser light) from the laser beam exiting head 30 of the blue laser welding system 100 is set to be perpendicular to the upper side of the stacked metal foils LF50, and then the blue laser beam 70 (blue laser light) is radiated from the upper side to the lower side of the stacked metal foils LF50 (step St2). Accordingly, a part of each copper foil constituting the stacked metal foils LF50 that is irradiated with the blue laser beam 70 gradually melts.

After an end of the irradiation with the blue laser beam 70, melting of the copper foils of the stacked metal foils LF50 converges and solidification starts (step St3). By the irradiation with the blue laser beam 70, the gap (particularly, gap on the side close to the tapered surfaces LTP1 and RTP1 of the stacked metal foils LF50) between the copper foils of the stacked metal foils LF50 is narrower than the gap (particularly, gap on the side close to the tapered surfaces LTP1 and RTP1 of the stacked metal foils LF50) between the copper foils of the stacked metal foils LF50 before the irradiation. That is, as described with reference to FIG. 4, the gap between the copper foils is narrowed (shortened) by a tensile force in the horizontal direction (see FIG. 4) when the copper foils stacked from the flat top surface TOP1 to the pair of tapered surfaces LTP1 and RTP1 are melted. Further, the forces F1 and F2 against the thermal contraction (in other words, generated in directions opposite to the directions of the thermal contraction (see the above description, see the eight dotted arrows in FIG. 6)) due to the irradiation with the blue laser beam 70 start to be generated in an entire melted region MLT1 (see FIG. 6) of the stacked metal foils LF50.

When the solidification of the copper foils of the stacked metal foils LF50 converges, the laser welding of the stacked metal foils LF50 ends (step St4). At a time point of step St4 (that is, at a time of solidification convergence), as compared with that at a time point of step St3 (in-melting to start of solidification), the gap (particularly, gap on the side close to the tapered surfaces LTP1 and RTP1 of the stacked metal foils LF50) between the copper foils of the stacked metal foils LF50 is further narrower than the gap (particularly, gap on the side close to the tapered surfaces LTP1 and RTP1 of the stacked metal foils LF50) between the copper foils of the stacked metal foils LF50 before the irradiation. Further, as compared with that at the time point of step St3, in the entire melted region MLT1 (see FIG. 6) of the stacked metal foils LF50, the forces F1 and F2 against the thermal contraction (in other words, generated in the directions opposite to the directions of the thermal contraction (see the above description, see the eight dotted arrows in FIG. 6)) due to the irradiation with the blue laser beam 70 reduce the curvature of the end surface in the lower portion (lower end surface) of the melted region of the stacked metal foils LF50 to the center side of the melted region MLT1 (see FIG. 6), thereby obtaining a structure that does not curve. That is, in a cross section of the stacked metal foils LF50 along the stacking direction of the copper foils, a cross-sectional shape is obtained in which the melted region MLT1 (see FIG. 6) has a three-dimensionally cylindrical shape. When a width of the entire melted region is small in the stacking direction, the copper foils may be broken by an external force applied during installation. A central part of the melted region MLT1 (see FIG. 6) of the stacked metal foils LF50 may be, however, narrower than an upper portion and a lower portion of the stacked metal foils LF50 since an external force is less likely to be applied to the central part when installing a battery to be mounted on an electronic device, an electric vehicle, and the like during production (manufacturing).

For example, as illustrated in FIG. 6, as a result of the first laser welding with the blue laser beam 70, in the cross section of the stacked metal foils LF50 along the stacking direction of the copper foils, the end surface (lower end surface BTM1) in the lower portion of the melted region MLT1 (see FIG. 6) of the stacked metal foils LF50 does not curve to the center side of the melted region MLT1 (see FIG. 6) of the stacked metal foils LF50. Originally, the amount of melting is large and a conductive region is wide on an irradiation side of the blue laser beam 70. Accordingly, an end surface (upper end surface UPP1) in an upper portion of the melted region MLT1 (see FIG. 6) of the stacked metal foils LF50 curves to the center side of the melted region MLT1 (see FIG. 6) of the stacked metal foils LF50. Such a curved portion, however, is not a concave portion having a large depth, and it is considered that electrical conductivity does not deteriorate due to the curved portion.

For example, as illustrated in FIG. 7, as a result of the second laser welding with the blue laser beam 70 for confirming reproducibility, in the cross section of the stacked metal foils LF50 along the stacking direction of the copper foils, the end surface (lower end surface BTM1) in the lower portion of the melted region MLT1 (see FIG. 7) of the stacked metal foils LF50 does not curve to the center side of the melted region MLT1 (see FIG. 7) of the stacked metal foils LF50, or reversely curves to bulge downward from the center side. Originally, the amount of melting is large and the conductive region is wide on the irradiation side of the blue laser beam 70. Accordingly, similar to FIG. 6, the end surface (upper end surface UPP1) in the upper portion of the melted region MLT1 (see FIG. 7) of the stacked metal foils LF50 curves to the center side of the melted region MLT1 (see FIG. 7) of the stacked metal foils LF50. Such a curved portion, however, is not a concave portion having a large depth, and it is considered that electrical conductivity does not deteriorate due to the curved portion.

Next, a comparative example of results of laser welding depending on the shape (particularly, tapered surface) of the jig JG1 will be described with reference to FIG. 8. FIG. 8 illustrates a comparative example of results of laser welding depending on the shape of the jig. In FIG. 8, results of laser welding experiments performed by selecting, for example, three types of shapes, are summarized and illustrated in a table.

For example, in sample #1, as a result of performing laser welding by wobbling (for example, width of 600 μm and frequency of 300 Hz) when a base shape (that is, shape of a jig) is a rectangular parallelepiped shape with no tapered surface, it was found that a hole was generated in a front surface of a melted region (that is, upper side of the stacked metal foils LF50). Here, the wobbling is a welding method of drawing a wobbling pattern such as a circle and an ellipse at a high speed in a portion to be welded. By the wobbling, it is possible to stabilize a melting state and improve a welding quality. On the other hand, even when the wobbling method is used, a hole may be formed when a workpiece has a rectangular parallelepiped shape. For this reason, when a jig has a rectangular parallelepiped shape, it is difficult to perform high-quality laser welding on stacked metal foils including a plurality of stacked copper foils.

For example, in sample #2, as a result of performing laser welding when a base shape (that is, shape of a projecting portion of a jig) is not a rectangular parallelepiped shape but a trapezoidal columnar shape with a tapered surface, it was found that laser welding was performed appropriately (that is, w1>w3 and w2>w3 illustrated in FIGS. 6 and 7 were satisfied) without forming a hole in a front surface of a melted region (that is, upper side of the stacked metal foils LF50). For example, a ratio of width between an upper side and a lower side of a projecting portion of the sample #2 is 4:5. For this reason, when a projecting portion of a jig has a tapered surface in which a ratio of width between an upper side and a lower side satisfies “3:5 to 1:1”, it is possible to perform high-quality laser welding on stacked metal foils including a plurality of stacked copper foils.

For example, in sample #3, as a result of performing laser welding when a base shape (that is, shape of a projecting portion of a jig) is not a rectangular parallelepiped shape but a trapezoidal columnar shape with a tapered surface, it was found that laser welding was performed appropriately (that is, w1>w3 and w2>w3 illustrated in FIGS. 6 and 7 were satisfied) without forming a hole in a front surface of a melted region (that is, upper side of the stacked metal foils LF50). For example, a ratio of width between an upper side and a lower side of a projecting portion of the sample #3 is 3:5. For this reason, when a projecting portion of a jig has a tapered surface in which a ratio of width between an upper side and a lower side satisfies “3:5 to 1:1”, it is possible to perform high-quality laser welding on stacked metal foils including a plurality of stacked copper foils.

As described above, a laser welding method for stacked metal foils according to the present embodiment includes: vertically stacking a plurality of copper-based foils; arranging the stacked metal foils LF50 on the jig JG1 in the blue laser welding system 100; and irradiating the stacked metal foils LF50 with a blue laser beam set to face toward a prescribed direction. After the irradiation with the blue laser beam, in a cross section of the stacked metal foils LF50 along a stacking direction of the copper-based foils, the lower end surface BTM1 of the melted region MLT1 generated in the stacked metal foils LF50 does not curve to a center side of the melted region MLT1. Accordingly, according to the laser welding method for stacked metal foils, it is possible to prevent a melted portion on a lower end side in the stacking direction of the stacked metal foils LF50 from curving to the center side of the melted portion regardless of presence and absence of a deviation of an irradiation position of blue laser light (blue laser beam 70) and a variation in the metal foils. Therefore, it is possible to achieve high-quality laser welding of a copper-based material, which has been said to be difficult to perform laser welding in the related art, while shortening a takt time.

The projecting portion PJ1 of the jig (jig JG1) has the flat top surface TOP1 on which the plurality of copper-based foils are arranged, and a pair of tapered surfaces LTP1 and RTP1 inclined substantially in a direction of gravity from respective two ends of the flat top surface TOP1 to left and right. Thus, according to the laser welding method for stacked metal foils, a gap (particularly, gap on a side close to the tapered surfaces LTP1 and RTP1) between the copper foils constituting the stacked metal foils LF50 can be further reduced or eliminated.

The plurality of copper-based foils are arranged over the flat top surface TOP1 and the pair of tapered surfaces LTP1 and RTP1, and are fixed by the clamp portions CLL and CLR that respectively face the pair of tapered surfaces LTP1 and RTP1. Thus, according to the laser welding method for stacked metal foils, the stacked metal foils LF50 are stably gripped while being irradiated with the blue laser beam 70, so that the melted region is appropriately formed without deterioration (surface irregularities such as holes and weld bead defects) in welding quality.

After the irradiation with the blue laser beam 70, the lower end surface BTM1 of the melted region MLT1 is flat (planar) or curves opposite to the center side of the melted region MLT1 in the cross section (cross section of the stacked metal foils LF50 along the stacking direction of the copper-based foils). Thus, according to the laser welding method for stacked metal foils, in the cross section along the stacking direction of the copper foils of the stacked metal foils LF50, a cross-sectional shape in which the melted region MLT1 has a three-dimensionally cylindrical shape can be obtained, a structure in which the electrical conductivity is less likely to deteriorate can be obtained, and high-quality laser welding can be implemented.

Further, in the cross section (cross section along the stacking direction of the copper-based foils of the stacked metal foils LF50), a ratio of a width (width l1) of the flat top surface TOP1 to a width (width l2) of a bottom surface of the projecting portion PJ1 of the jig JG1 is 3:5 or more. Thus, according to the laser welding method for stacked metal foils, no welding defect such as a hole would occur in the melted region formed by irradiation with the blue laser beam 70, and high-quality laser welding can be implemented.

Wobbling or weaving is used in the irradiation with the blue laser beam. Here, weaving is a welding method in which laser welding is performed while swinging the blue laser beam 70 to left and right relative to a welding line. Accordingly, when wobbling is used, a melting state of the melted region MLT1 formed by irradiation with the blue laser beam 70 can be stabilized, and the welding quality can be improved. When weaving is used, laser welding can be performed with a small number of passes (in other words, the number of times of welding), and the takt time of the entire laser welding can be reduced.

Although the embodiment have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the embodiment described above may be combined freely in a range without departing from the spirit of the invention.

It should be noted that the present application is based on a Japanese patent application (JP2023-001232) filed on Jan. 6, 2023, the contents of which are incorporated herein by reference.

What is claimed is:

1. A laser welding method for stacked metal foils including a plurality of stacked copper-based foils, the method comprising:
vertically stacking the plurality of copper-based foils;
arranging the stacked metal foils on a jig in a blue laser welding system; and
irradiating the stacked metal foils with a blue laser beam set to face toward a prescribed direction, wherein
after the irradiation with the blue laser beam, in a cross section of the stacked metal foils along a stacking direction of the copper-based foils, a lower end surface of a melted region generated in the stacked metal foils does not curve to a center side of the melted region.

2. The laser welding method for the stacked metal foils according to claim 1, wherein
the jig has a flat top surface on which the plurality of copper-based foils are arranged, and a pair of tapered surfaces inclined substantially in a gravity direction from the flat top surface respectively to left and right.

3. The laser welding method for the stacked metal foils according to claim 2, wherein
the plurality of copper-based foils are arranged over the flat top surface and the pair of tapered surfaces, and are fixed by clamp portions that respectively face the pair of tapered surfaces.

4. The laser welding method for the stacked metal foils according to claim 1, wherein
after the irradiation with the blue laser beam, in the cross section, the lower end surface of the melted region is flat or curves opposite to the center side of the melted region.

5. The laser welding method for the stacked metal foils according to claim 2, wherein
in the cross section, a ratio of a width of the flat top surface to a width of a bottom surface of the jig is 3:5 or more.

6. The laser welding method for the stacked metal foils according to claim 1, wherein
wobbling or weaving is used in the irradiation with the blue laser beam.
